(19) United States
(12) Patent Application Publication
(10) Pub. No.: US 2025/0211265 A1
(43) Pub. Date: Jun. 26, 2025

(54) Method and apparatus for digital pre-distortion adaptation

(71) Applicant: Intel Corporation, Santa Clara, CA (US)

(72) Inventors: Kameran AZADET, San Ramon, CA (US); Ramon SANCHEZ, Galapagar MD (ES); Hazar YUKSEL, San Francisco, CA (US); Kannan RAJAMANI, Basking Ridge, NJ (US); Zoran ZIVKOVIC, Hertogenbosch (NL); Albert MOLINA, Novelda (ES)

(21) Appl. No.: 18/389,826

(22) Filed: Dec. 20, 2023

(51) Int. Cl. H04B 1/04

(52) U.S. Cl. CPC H04B 1/0475

(57) ABSTRACT

A method and apparatus configured for digital pre-distortion (DPD) adaptation. The apparatus may include DPD circuitry and DPD adaptation circuitry. The DPD circuitry is configured to process input data using a pre-distortion function to generate pre-processed input data that is to be subsequently processed by a non-linear system. The pre-distortion function is represented as a sum of a plurality of non-linear terms, and non-linear effects of the non-linear system are compensated by the DPD circuitry. The DPD adaptation circuitry is configured to adapt coefficients of the DPD circuitry based on feedback information derived from an output signal of the non-linear system. The DPD adaptation circuitry is configured to adapt the plurality of non-linear terms of the pre-distortion function one non-linear term at a time. The pre-distortion function may be evaluated using look-up tables (LUTs). The LUTs may be adapted one LUT at a time in a round robin fashion.

### BACKGROUND

Digital pre-distortion (DPD) is an effective scheme to linearize a non-linear system, such as a power amplifier (PA). Adaptive power amplifier DPD is commonly used today. One of the challenges is the ability to track fast changes. Two conventional algorithms are Least Mean Square (LMS) adaptation and Least Square (LS) algorithm. LMS algorithm is very simple but can have slow convergence. LS adaptation has fast convergence, but it is computationally complex.

### BRIEF DESCRIPTION OF THE FIGURES

Some examples of apparatuses and/or methods will be described in the following by way of example only, and with reference to the accompanying figures, in which

FIG. 1 shows a non-linear system;

FIG. 2 shows an example apparatus including DPD circuitry in front of a non-linear system for linearizing the non-linear system;

FIG. 3 is a block diagram of an example DPD system configured for indirect adaptation of DPD coefficients;

FIG. 4 is a block diagram of an example DPD system configured for direct adaptation of DPD coefficients;

FIG. 5 is a flow diagram of an example process for adapting DPD;

FIG. 6 illustrates a user device in which the examples disclosed herein may be implemented; and

FIG. 7 illustrates a base station or infrastructure equipment radio head in which the examples disclosed herein may be implemented.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural clements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

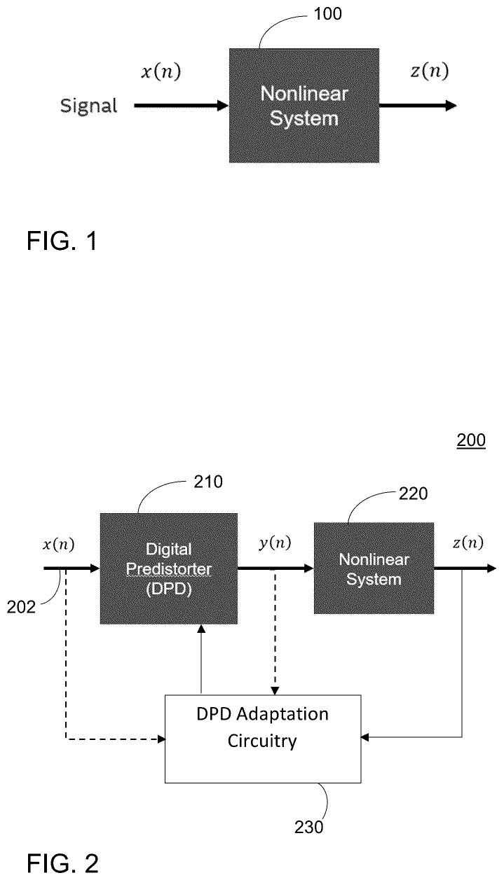

FIG. 1 shows a non-linear system 100. The non-linear system 100 (e.g., a digital-to-analog converter (DAC), a power amplifier (PA), etc.) receives an input signal x(n) and generate an output signal z(n). Due to the non-linear effects of the non-linear system 100, non-linear distortions such as harmonics and intermodulation may be present at the output signal z(n).

FIG. 2 shows an example apparatus 200 including DPD circuitry 210 in front of a non-linear system 220 for linearizing the non-linear system 220, in which aspects of the present application may be implemented. The non-linear system 220 may include a DAC, a power amplifier (PA), or any other device having non-linear characteristics. In order to eliminate the unwanted distortion (such as harmonics and intermodulation) at the output of the non-linear system 220, DPD circuitry 210 is provided in front of the non-linear system 220. The DPD circuitry 210 receives an input signal x(n) and modifies/pre-distorts the input signal to generate an output signal y(n). The DPD circuitry 210 may implement a mathematical model that produces an approximation of the inverse function of the non-linear system 220. By pre-distorting the input signal to the non-linear system 220 the non-linear effects of the non-linear system 220 can be compensated and the output of the non-linear system 220 may be linearized.

The non-linear system 220 may be modeled using polynomial functions (including piece-wise polynomial functions) to characterize the non-linear response of the system. The terms (e.g., polynomial terms) of the mathematical model for the DPD typically resemble that of the non-linearity with different parameters. Polynomial-based DPD systems receive input samples and applies the polynomial functions of the model to the input samples to generate pre-distorted DPD outputs. More specifically, the polynomial DPD systems may evaluate each of a set of polynomials given one or more input samples, apply the polynomial outputs as a non-linear gain factor to a function of the input samples, and sum the resulting samples to generate the DPD output. Assuming a suitable selection of modeling polynomials, the pre-distorted outputs may represent the inverse of the actual non-linearities of the non-linear system, which may be substantially canceled when the DPD outputs are applied as input to the non-linear system. The non-linear polynomial may be a linear combination of basis functions. Each basis function may be a symmetrical multi-dimensional polynomial taking, as input variables, a magnitude or power of input signals.

Polynomial-based DPD systems may either depend only on the current input sample (i.e., a memoryless polynomial model) or may depend on the current input sample in addition to one or more past input samples (i.e., a polynomial model with memory). The polynomial models with memory may present the DPD model as the sum of a plurality of terms, where each term is the product of a function of the current and/or previous input samples and a polynomial that is a function of the magnitude or power of the current or previous input samples. Accordingly, a DPD polynomial model with memory may evaluate each of a set of polynomials at one or more input samples, apply each polynomial output as a gain factor to a function of one or more input samples, and sum the resulting products to produce the overall DPD output.

A DPD polynomial model may need to evaluate each of the set of polynomials in order to produce each DPD output sample. In order to reduce computational burden, polynomial DPD systems may utilize one or more look-up tables (LUTs) to generate the DPD outputs. As opposed to directly evaluating each polynomial, DPD LUT systems may evaluate each of the polynomials over a wide range of input samples and may store the resulting outputs in a separate LUT. The LUT-based DPD systems may evaluate each LUT according to the received input samples and produce an LUT output value for each LUT. The LUT-based DPD systems may then produce the DPD output by applying the LUT output values as a set of gains to the corresponding function of input samples, thus avoiding direct evaluation of each polynomial.

The DPD system 210 may utilize adaptable LUTs that dynamically adjust the LUT coefficients for each LUT based on feedback from the output of the non-linear system 220. A DPD adaptation circuity 230 may perform adaptation of the LUT coefficients utilizing the feedback information derived from the output of the non-linear system 220. The DPD adaptation circuitry 230 may be a part of the DPD system 210. The DPD adaptation circuitry 230 may attempt to correct for any inaccuracies in the LUT coefficients that are observable through non-linearities detected in the output of the non-linear system 220. The DPD adaptation circuitry 230 may employ an adaptation scheme such as LS, LMS, or the like based on either indirect or direct learning to adapt the LUT coefficients of the DPD system 210. The DPD adaptation circuitry 230 may dynamically adapt the LUT coefficients over time based on observations of the outputs of the non-linear system 220.

An example apparatus for DPD adaptation is explained hereafter with reference to FIG. 2. The apparatus is configured for dynamically adapting DPD parameters (coefficients). The apparatus includes DPD circuitry 210 and DPD adaptation circuitry 230. The DPD circuitry 210 is configured to process the input data 202 using a pre-distortion function to generate pre-processed input data. The pre-processed input data is subsequently processed by a non-linear system 220 to generate an output signal. The pre-distortion function is represented as a sum of a plurality of non-linear terms. The non-linear effects of the non-linear system 220 are compensated by the DPD circuitry 210. As an example, the non-linear system 220 may be a PA.

The pre-distortion function implemented by the DPD circuitry 210 may be represented as a sum of a plurality of non-linear terms. For example, one example model for compensating memory and non-linear characteristics of a PA (or any non-linear system) is a memory polynomial model. The complex baseband representation of the memory polynomial model can be written as follows:

$$y [ n ] = {\sum }_{l = 0}^{L - 1} {\sum }_{m = 0}^{M - 1} {a}_{ml} x [ n - m ] {\vert x [ n - m ] \vert}^{l} ,$$

where x[n] is the input signal, y[n] is the pre-distorted input signal by the DPD circuitry, aml is the DPD coefficients, L is the non-linearity order, and M is the memory depth. It should be noted that the above model is merely an example, and different non-linearity models may also be used.

The DPD adaptation circuitry 230 is configured to adapt the DPD coefficients based on feedback information derived from the output signal of the non-linear system 220. The DPD adaptation circuitry 230 is configured to perform the adaptation of the non-linear terms of the pre-distortion function iteratively. In examples, the adaptation of the non-linear terms of the pre-distortion function is performed on a per-non-linear term basis, i.e., the non-linear terms of the DPD are adapted iteratively one non-linear term at a time.

In order to reduce computational burden, the pre-distortion function may be evaluated using a plurality of LUTs. The DPD circuitry 210 may evaluate each LUT according to the received input samples to produce an LUT output for each LUT. In examples, in case where the DPD is implemented with a plurality of LUTs, the coefficients of the LUTs may be adapted one LUT at a time. The adaptation of the LUTs may be performed in a round robin fashion. The adaptation of the first LUT is performed in a first round, the adaptation of the second LUT is performed in a second round, and so on.

The DPD adaptation is performed based on the feedback information derived from the output signal of the non-linear system 220 (i.e., based on the output samples of the non-linear system 220). In examples, the DPD adaptation circuitry 230 may be configured to adapt the coefficients of the LUTs by repeating multiple iterations with the same samples of the output signal of the non-linear system. With each capture of a set of PA output samples, multiple iterations may be performed for all LUTs, i.e., the adaptation of each LUT may be performed with multiple iterations with the same set of PA output samples.

The LUT adaptation may be performed either indirectly or directly. For indirect learning, the DPD adaptation circuitry 230 may be configured to adapt the coefficients of the LUTs based on the pre-processed input data by the DPD circuitry 210 and the feedback information derived from the output signal of the non-linear system 220. For direct learning, the DPD adaptation circuitry 230 may be configured to adapt the coefficients of the LUTs based on the input data 202 and the feedback information derived from the output signal of the non-linear system 220. The DPD adaptation circuitry 230 may be configured to adapt the non-linear terms using least square algorithm, or alternatively using different adaptation algorithm. The DPD circuitry 210 may be configured to evaluate each LUT based on the input data to produce an LUT output value for each LUT and generate the pre-processed input data by applying the LUT output value as a gain to a corresponding function of the input data.

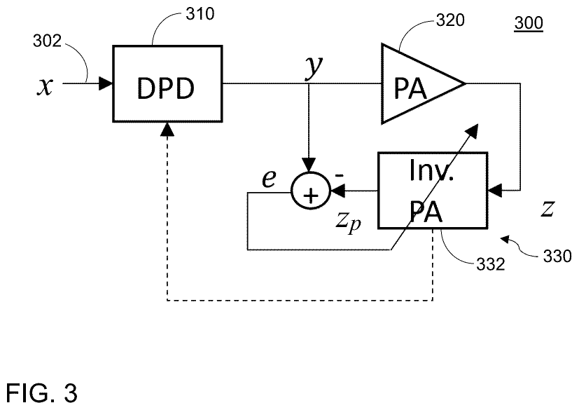

FIG. 3 is a block diagram of an example DPD system configured for indirect adaptation of DPD coefficients. The system 300 includes a DPD circuitry 310, a PA 320, and a DPD adaptation circuitry 330. The PA 320 is an example of a non-linear system, and the non-linear system may include a different and/or additional component(s). The input data 302 is processed by the DPD circuitry 310 and the output of the DPD circuitry 310 is processed by the PA 320. The output of the PA 320 is sampled/captured, and the input of the PA 320 and the output of the PA 320 are processed by the DPD adaptation circuitry 330 for adapting/updating the coefficients of the DPD circuitry 310.

The DPD adaptation circuitry 330 includes an inverse PA model 332 (e.g., an adaptative digital filter) that models the inverse of the non-linearity of the PA 320. The inverse PA model 332 is identified by using the output of the PA 320 to predict the input of the PA 320. The difference (error e) between the input of the PA 320 and the output of the inverse PA model 332 is determined and the inverse PA model 332 is updated based on the error e. The estimated parameters of the inverse PA model 332 may be used as the coefficients for the DPD circuitry 310 to pre-distort the input data 302.

In some examples, the DPD circuitry 310 may include a plurality of LUTs for evaluating the pre-distortion function. The entry values (coefficients) of all LUTs may be derived, for example using least square (LS) algorithm, or the like. The LUT coefficients (w) may be derived as follows:

$${z}_{p} = Aw . \\ e = {z}_{p} - y .$$

where zₚ=[zₚ(1), . . . , zₚ(N)]^{T}, A=[uₒₒ, . . . , u_{oL}, . . . , uₘₗ, . . . , u_{Mo}, . . . , u_{ML}]_{N×ML}, uₘₗ=[∅ₘₗ[z(1)], . . . , ∅ₘₗ[z(N)]]^{T}, ∅ₘₗ[z(n)]=z[n−m]|z[n−m]|^{l}, and w=[wₒₒ, . . . , w_{oL}, . . . , wₘₗ, . . . , w_{Mo}, . . . , w_{ML}]^{T}. L is the number of entries of each look-up table (e.g., 128), M is the number of LUTs (e.g., memory terms), N is the input/output data block size for the adaptation (e.g., the number of samples of the input data and the captured PA output), w is an LUT coefficient vector of ML×1 entry values of all M LUTs, x is the N×1 vector of DPD input data, y is the N×1 vector of pre-distorted input data, z is the N×1 vector of PA observation captured data, zₚ is the N×1 vector of inverse PA model output, e is the N×1 vector of error signal, and A is the N×ML matrix of basis functions of z as column vectors and the samples in time as row index. The LUT coefficient vector w may be derived as follows:

$$e = Aw - y . \\ C = {e}^{H} e = ( {w}^{H} {A}^{H} - {y}^{H} ) ( Aw - y ) . \\ C = {w}^{H} ( {A}^{H} A ) w - {y}^{H} Aw - {w}^{H} {A}^{H} y + {y}^{H} y . \\ ∇ C = 2 ( {A}^{H} A ) w - {A}^{H} y - {A}^{H} y = 2 ( ( {A}^{H} A ) w - {A}^{H} y ) = 0. \\ ( {A}^{H} A ) w - {A}^{H} y = 0. \\ w = {( {A}^{H} A )}^{- 1} {A}^{H} y .$$

In this case, the matrix sizes become too large to be practical in systems having insufficient memory. The complexity is high and the inversion of the large auto-correlation matrix A^{H}A requires very high accuracy. For example, if M=128, L=32, and N=8,192, the matrix size of A is 8,192×4,096, which requires 134,217,728 megabyte of memory for matrix A, and requires 67,108,864 megabyte of memory for matrix A^{H}A.

In accordance with example schemes disclosed herein, the indirect adaptation of the LUTs may be performed on a per-LUT basis. The LUT entries w (of all LUTs) may be written as follows:

$$w = {S}_{1} {w}_{1} + {S}_{2} {w}_{2} + … + {S}_{M} {w}_{M} = {S}_{j} {w}_{j} + \overline{{w}_{j}} ,$$

where w is an ML×1 vector of coefficients of all LUTs where M is the number of LUTs (e.g., the number of memory terms) and L is the number of entries in each LUT. wⱼ is the LUT coefficients of LUT j where j∈{1, . . . , M}, and each wⱼ is an L×1 vector. W̅_{J} is an ML×1 vector of all LUT coefficients other than LUT j (i.e., w with 0s in place of LUT index j). Sₖ is a selector matrix that converts an L×1 vector into an ML×1 vector with all zeros except for the k-th L×1 components.

The processes for deriving the LUT coefficients using indirect adaptation are as follows:

$$C = {w}^{H} ( {A}^{H} A ) w - {y}^{H} Aw - {w}^{H} {A}^{H} y + {y}^{H} y . \\ C = ( {w}_{j}^{H} {S}_{j}^{H} + \overline{{w}_{j}^{H}} ) ( {A}^{H} A ) ( {S}_{j} {w}_{j} + \overline{{w}_{j}} ) - {y}^{H} A ( {S}_{j} {w}_{j} + \overline{{w}_{j}} ) - ( {w}_{j}^{H} {S}_{j}^{H} + \overline{{w}_{j}^{H}} ) {A}^{H} y + {y}^{H} y . \\ C = {w}_{j}^{H} {S}_{j}^{H} ( {A}^{H} A ) {S}_{j} {w}_{j} + {w}_{j}^{H} {S}_{j}^{H} ( {A}^{H} A ) \overline{{w}_{j}} + \overline{{w}_{j}^{H}} ( {A}^{H} A ) {S}_{j} {w}_{j} + \overline{{w}_{j}^{H}} ( {A}^{H} A ) \overline{{w}_{j}} - {y}^{H} {AS}_{j} {w}_{j} - {y}^{H} {AS}_{j} \overline{{w}_{j}} - {w}_{j}^{H} {S}_{j}^{H} {A}^{H} y - \overline{{w}_{j}^{H}} {A}^{H} y + {y}^{H} y . \\ {∇}_{{w}_{j}} C = 2 {S}_{j}^{H} ( {A}^{H} A ) {S}_{j} {w}_{j} + {S}_{j}^{H} ( {A}^{H} A ) \overline{{w}_{j}} + {S}_{j}^{H} ( {A}^{H} A ) \overline{{w}_{j}} - {S}_{j}^{H} {A}^{H} y - {S}_{j}^{H} {A}^{H} y = 2 ( {S}_{j}^{H} ( {A}^{H} A ) {S}_{j} {w}_{j} + {S}_{j}^{H} ( {A}^{H} A ) \overline{{w}_{j}} - {S}_{j}^{H} {A}^{H} y ) . \\ {∇}_{{w}_{j}} C = 0. \\ {S}_{j}^{H} ( {A}^{H} A ) {S}_{j} {w}_{j} + {S}_{j}^{H} ( {A}^{H} A ) \overline{{w}_{j}} - {S}_{j}^{H} {A}^{H} y = 0. \\ {w}_{j} = {( {S}_{j}^{H} ( {A}^{H} A ) {S}_{j} )}^{- 1} ( {S}_{j}^{H} ( {A}^{H} A ) \overline{{w}_{j}} - {S}_{j}^{H} {A}^{H} y ) . \\ {w}_{j} = {( {S}_{j}^{H} ( {A}^{H} A ) {S}_{j} )}^{- 1} {S}_{j}^{H} {A}^{H} ( y - A \overline{{w}_{j}} ) .$$

Let Aⱼ=ASⱼ. Basis functions matrix only relating to LUT j are:

$${w}_{j} = - {( {A}_{j}^{H} {A}_{j} )}^{- 1} {A}_{j}^{H} {e}_{j} .$$

eⱼ is an N×1 vector, Aⱼ is an N×L matrix. Aⱼ^{H}Aⱼ is tri-diagonal which is a great property for matrix inversion and storage. The error when LUT j is zeroed out may be determined as:

$${e}_{j} = A \overline{{w}_{j}} - y .$$

In this example, the matrix size is orders of magnitude smaller and the inversion of auto-correlation matrix becomes more feasible. For example, if M=128, L=32, and N=8,192, the matrix Aⱼ is a size of 8192×32, which requires 1,048,576 kilobyte of memory for matrix A, and requires 32,768 kilobyte of memory for matrix A^{H}A. Orders of magnitude reduction of memory requirements and complexity makes the example schemes disclosed herein practical in DPD systems.

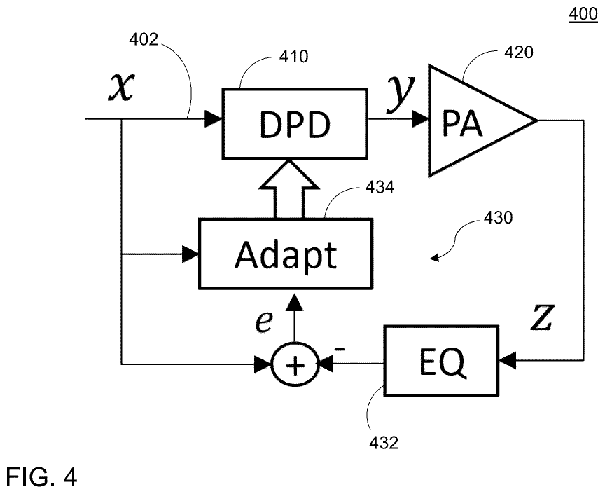

FIG. 4 is a block diagram of an example DPD system configured for direct adaptation of DPD coefficients. In direct adaptation, the DPD coefficients are directly adapted which is more resilient to feedback receiver (RX) noise. The system 400 includes a DPD circuitry 410, a PA 420, and a DPD adaptation circuitry 430. The input data 402 is processed by the DPD circuitry 410 and then processed by the PA 420. The output of the PA 420 is sampled and equalized. The DPD input 402 and the equalized output of the PA 420 are processed by the DPD adaptation circuitry 430 for adjusting/updating the coefficients of the DPD circuitry 410. The difference (error e) between the DPD input 402 and the equalized output of the PA 420 is determined and the DPD is adjusted based on the error e. The DPD may be implemented with a plurality of LUTs.

The entry values of all LUTs may be derived using LS algorithm (alternatively different adaptation algorithm may be used) as follows:

$$e = g A w - x .$$

A linear model for the PA is used with a PA gain g. L is the number of entries of each look-up table, M is the number of LUTs (e.g., memory terms), N is the input/output data block size for the adaptation (e.g., the number of samples of the input data and the captured PA output), w is a LUT coefficient vector of ML×1 entry values of all M LUTs, x is the N×1 vector of DPD input data, y is the N×1 vector of pre-distorted input data, z is the N×1 vector of PA observation captured data, e is the N×1 vector of error signal, and A is the N×ML matrix of basis functions for the samples z as column vectors and the samples in time as row index.

The LUT coefficients may be derived using direct adaptation as follows:

$$\begin{matrix}C = {e}^{H} e = ( {g}^{*} {w}^{H} {A}^{H} - {x}^{H} ) ( g A w - x ) . \\ C = {\vert g \vert}^{2} {w}^{H} ( {A}^{H} A ) w - g {x}^{H} A w - {g}^{*} {w}^{H} {A}^{H} x + {x}^{H} x . \\ ∇ C = 2 {\vert g \vert}^{2} ( {A}^{H} A ) w - {g}^{*} {A}^{H} x - {g}^{*} {A}^{H} x = 2 ( ( {g}^{*} {A}^{H} g A ) w - {g}^{*} {A}^{H} x ) . \\ {g}^{*} {A}^{H} ( g A w - x ) = {g}^{*} {A}^{H} e . \\ w ← w - μ ∇ C .\end{matrix}$$

μ is the step size (learning rate) of gradient algorithm. ∇C refers to gradient of the real valued function C with respect to the real and imaginary part of the parameters w, written as a complex number.

Based on gradient algorithm, the LUT coefficients may be updated as follows:

$$w ← w - μ {g}^{*} {A}^{H} e .$$

Newton algorithm uses the curvature in addition to gradient to achieve faster convergence. Based on Newton algorithm, the LUT coefficients may be updated as follows:

$$\begin{matrix}w ← w - {μ ( {∇}^{2} C )}^{- 1} ∇ C . \\ {∇}^{2} C = 2 {\vert g \vert}^{2} {( {A}^{H} A )}^{H} = 2 {\vert g \vert}^{2} ( {A}^{H} A ) . \\ w ← w - μ {\vert g \vert}^{- 2} {( {A}^{H} A )}^{- 1} {g}^{*} {A}^{H} e .\end{matrix}$$

Based on damped-Newton algorithm, the LUT coefficients may be updated as follows:

$$w ← w - \frac{μ}{g} {( {A}^{H} A )}^{- 1} {A}^{H} e .$$

In examples, the LUT coefficients may be adapted on a per-LUT basis. Examples for per-LUT adaptation in direct adaptation of the LUTs will be explained hereafter with reference to FIG. 4. The LUT entries w may be written as follows:

$$\begin{matrix}w = {S}_{1} {w}_{1} + {S}_{2} {w}_{2} + … + {S}_{M} {w}_{M} = {S}_{j} {w}_{j} + {\overline{w}}_{j} . \\ C = {e}^{H} e = ( {g}^{*} {w}^{H} {A}^{H} - {x}^{H} ) ( g A w - x ) . \\ C = {\vert g \vert}^{2} {w}^{H} ( {A}^{H} A ) w - g {x}^{H} A w - {g}^{*} {w}^{H} {A}^{H} x + {x}^{H} x . \\ C = {\vert g \vert}^{2} ( {w}_{j}^{H} {S}_{j}^{H} + {\overline{w}}_{j}^{H} ) ( {A}^{H} A ) ( {S}_{j} {w}_{j} + {\overline{w}}_{j} ) - {gx}^{H} A ( {S}_{j} {w}_{j} + {\overline{w}}_{j} ) - {g}^{*} ( {w}_{j}^{H} {S}_{j}^{H} + {\overline{w}}_{j}^{H} ) {A}^{H} x + {x}^{H} x . \\ C = {\vert g \vert}^{2} ( {w}_{j}^{H} {S}_{j}^{H} ( {A}^{H} A ) {S}_{j} {w}_{j} + {w}_{j}^{H} {S}_{j}^{H} ( {A}^{H} A ) {\overline{w}}_{j} + {\overline{w}}_{j}^{H} ( {A}^{H} A ) {S}_{j} {w}_{j} + {\overline{w}}_{j}^{H} ( {A}^{H} A ) {\overline{w}}_{j} ) - {gx}^{H} A {S}_{j} {w}_{j} - {gx}^{H} A {S}_{j} {\overline{w}}_{j} - {g}^{*} {w}_{j}^{H} {S}_{j}^{H} {A}^{H} x - {g}^{*} {\overline{w}}_{j}^{H} {A}^{H} x + {x}^{H} x . \\ {∇}_{{w}_{j}} C = 2 ( {\vert g \vert}^{2} {S}_{j}^{H} ( {A}^{H} A ) {S}_{j} {w}_{j} + {\vert g \vert}^{2} {S}_{j}^{H} ( {A}^{H} A ) {\overline{w}}_{j} - {g}^{*} {S}_{j}^{H} {A}^{H} x ) . \\ {w}_{j} ← {w}_{j} - μ {g}^{*} {A}_{j}^{H} ( g A {S}_{j} {w}_{j} + gA {\overline{w}}_{j} - x ) ,\end{matrix}$$

where Aⱼ=ASⱼ.

$$g A {S}_{j} {w}_{j} + gA {\overline{w}}_{j} - x = gA ( {S}_{j} w + {\overline{w}}_{j} ) - x = gAw - x = e .$$

Based on gradient algorithm, the LUT coefficients may be updated as follows:

$${w}_{j} ← {w}_{j} - μ {g}^{*} {A}_{j}^{H} e .$$

Based on Newton algorithm, the LUT coefficients may be updated as follows:

$${∇}_{{w}_{j}}^{2} C = 2 {\vert g \vert}^{2} {( {A}_{j}^{H} {A}_{j} )}^{H} = 2 {\vert g \vert}^{2} ( {A}_{j}^{H} {A}_{j} ) .$$

Based on damped-Newton algorithm, the LUT coefficients may be updated as follows:

$${w}_{j} ← {w}_{j} - \frac{μ}{g} {( {A}_{j}^{H} {A}_{j} )}^{- 1} ( g A w - x ) .$$

The coefficients of the LUTs may be updated in a round robin fashion. The coefficients of all LUTs may be updated one LUT at a time. The coefficients of the first LUT is first determined, and then the process is repeated to update the coefficients of the second LUT, and the process is repeated to update the coefficients of the third LUT, and so on.

The update of the coefficients of the LUTs in a round robin fashion may be performed as follows:

$$\begin{matrix}{w}_{1} ← {w}_{1} + Δ {w}_{1} . \\ Δ {w}_{1} = - \frac{μ}{g} {( {A}_{1}^{H} {A}_{1} )}^{- 1} {A}_{1}^{H} e . \\ \overline{{w}_{2 : M}} ← \overline{{w}_{2 : M}} + {S}_{1} Δ {w}_{1} . \\ {w}_{2} ← {w}_{2} - μ {g}^{*} {A}_{2}^{H} ( g A ( w + {S}_{1} Δ {w}_{1} ) - x ) . \\ {w}_{2} ← {w}_{2} - μ {g}^{*} {A}_{2}^{H} ( e + g {A}_{1} Δ {w}_{1} ) . \\ {w}_{2} ← {w}_{2} - μ {g}^{*} {A}_{2}^{H} ( e - μ {{A}_{1} ( {A}_{1}^{H} {A}_{1} )}^{- 1} {A}_{1}^{H} e ) . \\ \overline{{w}_{3 : M}} ← \overline{{w}_{2 : M}} + {S}_{1} Δ {w}_{1} + {S}_{2} Δ {w}_{2} . \\ {w}_{3} ← {w}_{3} - μ {g}^{*} {A}_{2}^{H} ( g A ( w + {S}_{1} Δ {w}_{1} + {S}_{2} Δ {w}_{2} ) - x ) . \\ {w}_{3} ← {w}_{3} - μ {g}^{*} {A}_{2}^{H} ( e - μ {{A}_{1} ( {A}_{1}^{H} {A}_{1} )}^{- 1} {A}_{1}^{H} e - μ {{A}_{2} ( {A}_{2}^{H} {A}_{2} )}^{- 1} {A}_{2}^{H} e ) .\end{matrix}$$

Pseudo code for each capture may be as follows:
For k=1: #sub-iteration
For i=1: #LUTs

$$\begin{matrix}{B}_{i} = {( {A}_{i}^{H} {A}_{i} )}^{- 1} \\ Δ {w}_{i} = - \frac{μ}{g} {B}_{i} {A}_{i}^{H} e \\ e ← e - g {A}_{i} Δ {w}_{i} \\ {w}_{i} ← {w}_{i} + Δ {w}_{i}\end{matrix}$$

End
End

Alternatively, a simplified process may be performed using only diagonal elements of the matrix Aᵢ^{H}Aᵢ. Pseudo code for the simplified process may be as follows:
For k=1: #sub-iteration
For i=1: #LUTs

$$\begin{matrix}{B}_{i} = {( diag ( {A}_{i}^{H} {A}_{i} ) )}^{- 1} \\ Δ {w}_{i} = - \frac{μ}{g} {B}_{i} {A}_{i}^{H} e \\ e ← e - g {A}_{i} Δ {w}_{i} \\ {w}_{i} ← {w}_{i} + Δ {w}_{i}\end{matrix}$$

End
End

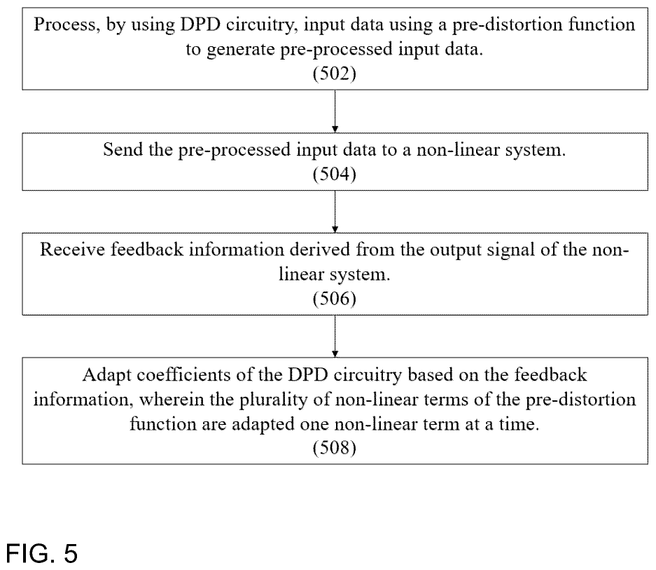

FIG. 5 is a flow diagram of an example process for adapting DPD. The method includes processing, by using DPD circuitry, input data using a pre-distortion function to generate pre-processed input data (502). The pre-distortion function is represented as a sum of a plurality of non-linear terms. The method includes sending the pre-processed input data to a non-linear system (504). The pre-processed input data is processed by the non-linear system to generate an output signal. Non-linear effects of the non-linear system are compensated by the processing by the DPD circuitry. The method includes receiving feedback information derived from the output signal of the non-linear system (506). The method includes adapting coefficients of the DPD circuitry based on the feedback information, wherein the plurality of non-linear terms of the pre-distortion function are adapted one non-linear term at a time (508). The adaptation of the non-linear terms of the pre-distortion function may be performed iteratively. In examples, the adaptation of the non-linear terms of the pre-distortion function is performed on a per-non-linear term basis, i.e., the non-linear terms of the DPD are adapted iteratively one non-linear term at a time.

In order to reduce computational burden, the pre-distortion function may be evaluated using a plurality of LUTs. Each LUT may be evaluated according to the received input samples to produce an LUT output for each LUT. In examples, in case where the DPD is implemented with a plurality of LUTs, the coefficients of the LUTs may be adapted one LUT at a time. The adaptation of the LUTs may be performed in a round robin fashion. The adaptation of the first LUT is performed in a first round, the adaptation of the second LUT is performed in a second round, and so on.

The DPD adaptation is performed based on the feedback information derived from the output signal of the non-linear system 220 (i.e., based on the output samples of the non-linear system 220). In examples, the coefficients of the LUTs may be adapted by repeating multiple iterations with the same samples of the output signal of the non-linear system. With each capture of a set of PA output samples, multiple iterations may be performed for all LUTs, i.e., the adaptation of each LUT may be performed with multiple iterations with the same set of PA output samples.

The LUT adaptation may be performed either indirectly or directly. For indirect learning, the coefficients of the LUTs may be adapted based on the pre-processed input data by the DPD circuitry 210 and the feedback information derived from the output signal of the non-linear system 220. For direct learning, the coefficients of the LUTs may be adapted based on the input data 202 and the feedback information derived from the output signal of the non-linear system 220. The non-linear terms may be adapted using least square algorithm, or alternatively using different adaptation algorithm. In one example, each LUT may be evaluated based on the input data to produce an LUT output value for each LUT and the pre-processed input data may be generated by applying the LUT output value as a gain to a corresponding function of the input data.

The example schemes disclosed herein can provide convergence speed similar to LS, but with order of magnitude less memory and lower complexity than LS. In examples, one LUT is adapted at a time by using multiple sub-iterations. Memory requirement is reduced by orders of magnitude making LS type of algorithm practical in systems where memory is limited. The example schemes disclosed herein can significantly reduce complexity of DPD adaptation while preserving the convergence speed similar to LS algorithm. Table 1 below shows the comparison of the complexity in terms of the required operations per second for the LS algorithm and the per-LUT LS algorithm.

TABLE 1

| LS algorithm | | Per-LUT LS algorithm | |
|---|---|---|---|
| A^{H} A | N × (ML)² | Aⱼ^{H} Aⱼ | N × L² |
| (A^{H} A)⁻¹ | (ML)³ | (Aⱼ^{H} Aⱼ)⁻¹ | L³ |
| A^{H} y | ML × N | Aⱼ^{H} eⱼ | L × N |
| (A^{H} A)⁻¹ A^{H} y | (ML)² | (Aⱼ^{H} Aⱼ)⁻¹ Aⱼ^{H}eⱼ | L² |
| | 180 Gops | | 66.8 Gops |

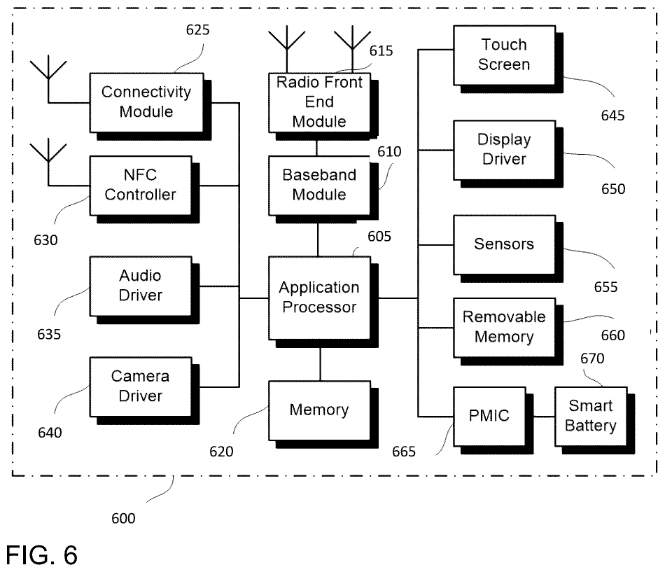

FIG. 6 illustrates a user device 600 in which the examples disclosed herein may be implemented. For example, the examples disclosed herein may be implemented in the radio front-end module 615, in the baseband module 610, etc. The user device 600 may be a mobile device in some aspects and includes an application processor 605, baseband processor 610 (also referred to as a baseband module), radio front end module (RFEM) 615, memory 620, connectivity module 625, near field communication (NFC) controller 630, audio driver 635, camera driver 640, touch screen 645, display driver 650, sensors 655, removable memory 660, power management integrated circuit (PMIC) 665 and smart battery 670.

In some aspects, application processor 605 may include, for example, one or more CPU cores and one or more of cache memory, low drop-out voltage regulators (LDOs), interrupt controllers, serial interfaces such as serial peripheral interface (SPI), inter-integrated circuit (I2C) or universal programmable serial interface module, real time clock (RTC), timer-counters including interval and watchdog timers, general purpose input-output (IO), memory card controllers such as secure digital/multi-media card (SD/MMC) or similar, universal serial bus (USB) interfaces, mobile industry processor interface (MIPI) interfaces and Joint Test Access Group (JTAG) test access ports.

In some aspects, baseband module 610 may be implemented, for example, as a solder-down substrate including one or more integrated circuits, a single packaged integrated circuit soldered to a main circuit board, and/or a multi-chip module containing two or more integrated circuits.

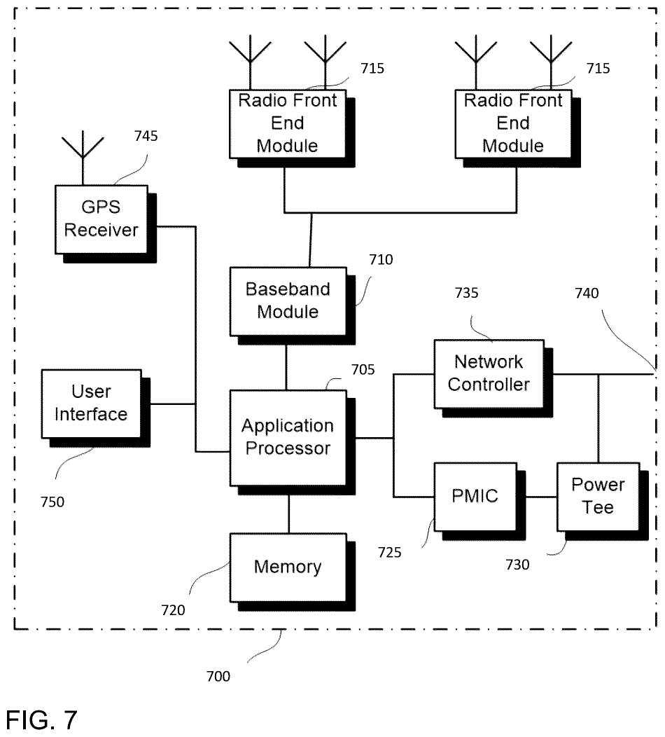

FIG. 7 illustrates a base station or infrastructure equipment radio head 700 in which the examples disclosed herein may be implemented. For example, the examples disclosed herein may be implemented in the radio front-end module 715, in the baseband module 710, etc. The base station radio head 700 may include one or more of application processor 705, baseband modules 710, one or more radio front end modules 715, memory 720, power management circuitry 725, power tee circuitry 730, network controller 735, network interface connector 740, satellite navigation receiver module 745, and user interface 750.

In some aspects, application processor 705 may include one or more CPU cores and one or more of cache memory, low drop-out voltage regulators (LDOs), interrupt controllers, serial interfaces such as SPI, I2C or universal programmable serial interface module, real time clock (RTC), timer-counters including interval and watchdog timers, general purpose IO, memory card controllers such as SD/MMC or similar, USB interfaces, MIPI interfaces and Joint Test Access Group (JTAG) test access ports.

In some aspects, baseband processor 710 may be implemented, for example, as a solder-down substrate including one or more integrated circuits, a single packaged integrated circuit soldered to a main circuit board or a multi-chip module containing two or more integrated circuits.

In some aspects, memory 720 may include one or more of volatile memory including dynamic random access memory (DRAM) and/or synchronous dynamic random access memory (SDRAM), and nonvolatile memory (NVM) including high-speed electrically erasable memory (commonly referred to as Flash memory), phase change random access memory (PRAM), magneto resistive random access memory (MRAM) and/or a three-dimensional crosspoint memory. Memory 720 may be implemented as one or more of solder down packaged integrated circuits, socketed memory modules and plug-in memory cards.

In some aspects, power management integrated circuitry 725 may include one or more of voltage regulators, surge protectors, power alarm detection circuitry and one or more backup power sources such as a battery or capacitor. Power alarm detection circuitry may detect one or more of brown out (under-voltage) and surge (over-voltage) conditions.

In some aspects, power tee circuitry 730 may provide for electrical power drawn from a network cable to provide both power supply and data connectivity to the base station radio head 700 using a single cable.

In some aspects, network controller 735 may provide connectivity to a network using a standard network interface protocol such as Ethernet. Network connectivity may be provided using a physical connection which is one of electrical (commonly referred to as copper interconnect), optical or wireless.

In some aspects, satellite navigation receiver module 745 may include circuitry to receive and decode signals transmitted by one or more navigation satellite constellations such as the global positioning system (GPS), Globalnaya Navigatsionnaya Sputnikovaya Sistema (GLONASS), Galileo and/or BeiDou. The receiver 745 may provide data to application processor 705 which may include one or more of position data or time data. Application processor 705 may use time data to synchronize operations with other radio base stations.

In some aspects, user interface 750 may include one or more of physical or virtual buttons, such as a reset button, one or more indicators such as light emitting diodes (LEDs) and a display screen.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to an apparatus configured for DPD adaptation. The apparatus may include DPD circuitry and DPD adaptation circuitry. The DPD circuitry is configured to process input data using a pre-distortion function to generate pre-processed input data that is to be subsequently processed by a non-linear system. The pre-distortion function is represented as a sum of a plurality of non-linear terms, and non-linear effects of the non-linear system are compensated by the DPD circuitry. The DPD adaptation circuitry is configured to adapt coefficients of the DPD circuitry based on feedback information derived from an output signal of the non-linear system. The DPD adaptation circuitry is configured to adapt the plurality of non-linear terms of the pre-distortion function one non-linear term at a time.

Another example, (e.g., example 2) relates to a previously described example (e.g., example 1), wherein the pre-distortion function is evaluated using a plurality of LUTs.

Another example, (e.g., example 3) relates to a previously described example (e.g., example 2), wherein the LUTs are adapted one LUT at a time in a round robin fashion.

Another example, (e.g., example 4) relates to a previously described example (e.g., any one of examples 2-3), wherein the DPD adaptation circuitry is configured to adapt coefficients of the LUTs by repeating multiple iterations with same samples of the output signal of the non-linear system.

Another example, (e.g., example 5) relates to a previously described example (e.g., any one of examples 2-4), wherein the DPD adaptation circuitry is configured to adapt coefficients of the LUTs based on the pre-processed input data and the feedback information derived from the output signal of the non-linear system.

Another example, (e.g., example 6) relates to a previously described example (e.g., any one of examples 2-5), wherein the DPD adaptation circuitry is configured to adapt coefficients of the LUTs based on the input data and the feedback information derived from the output signal of the non-linear system.

Another example, (e.g., example 7) relates to a previously described example (e.g., any one of examples 2-6), wherein the DPD circuitry is configured to evaluate each LUT based on the input data and produce an LUT output value for each LUT and generate the pre-processed input data by applying the LUT output value as a gain to a corresponding function of the input data.

Another example, (e.g., example 8) relates to a previously described example (e.g., any one of examples 1-7), wherein the DPD adaptation circuitry is configured to adapt the non-linear terms using least square algorithm.

Another example, (e.g., example 9) relates to a previously described example (e.g., any one of examples 1-8), wherein the non-linear system is a PA.

Another example, (e.g., example 10) relates to a method for adapting DPD. The method includes processing, using DPD circuitry, input data using a pre-distortion function to generate pre-processed input data, wherein the pre-distortion function is represented as a sum of a plurality of non-linear terms, sending the pre-processed input data to a non-linear system, wherein the pre-processed input data is processed by the non-linear system to generate an output signal, wherein non-linear effects of the non-linear system are compensated by the processing by the DPD circuitry, receiving feedback information derived from the output signal of the non-linear system, and adapting coefficients of the DPD circuitry based on the feedback information, wherein the plurality of non-linear terms of the pre-distortion function are adapted one non-linear term at a time.

Another example, (e.g., example 11) relates to a previously described example (e.g., example 10), wherein the pre-distortion function is evaluated using a plurality of LUTs.

Another example, (e.g., example 12) relates to a previously described example (e.g., example 11), wherein the LUTs are adapted one LUT at a time in a round robin fashion.

Another example, (e.g., example 13) relates to a previously described example (e.g., any one of examples 11-12), wherein coefficients of the LUTs are adapted by repeating multiple iterations with same samples of the output signal of the non-linear system.

Another example, (e.g., example 14) relates to a previously described example (e.g., any one of examples 11-13), wherein coefficients of the LUTs are adapted based on the pre-processed input data and the feedback information derived from the output signal of the non-linear system.

Another example, (e.g., example 15) relates to a previously described example (e.g., any one of examples 11-14), wherein coefficients of the LUTs are adapted based on the input data and the feedback information derived from the output signal of the non-linear system.

Another example, (e.g., example 16) relates to a previously described example (e.g., any one of examples 11-15), wherein each LUT is evaluated based on the input data to produce an LUT output value for each LUT and the pre-processed input data is generated by applying the LUT output value as a gain to a corresponding function of the input data.

Another example, (e.g., example 17) relates to a previously described example (e.g., any one of examples 10-16), wherein the non-linear terms are adapted using least square algorithm.

Another example, (e.g., example 18) relates to a previously described example (e.g., any one of examples 10-17), wherein the non-linear system is a PA.

Another example, (e.g., example 19) relates to a machine-readable medium including code, when executed, to cause a machine to perform the method as in any one of examples 10-18.

Another example, (e.g., example 20) relates to a computer program having a program code for performing the method as in any one of examples 10-18, when the computer program is executed on a computer, a processor, or a programmable hardware component.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that-although a dependent claim may refer in the claims to a specific combination with one or more other claims-other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. An apparatus configured for digital pre-distortion (DPD) adaptation, comprising:
DPD circuitry configured to process input data using a pre-distortion function to generate pre-processed input data that is to be subsequently processed by a non-linear system, wherein the pre-distortion function is represented as a sum of a plurality of non-linear terms, and non-linear effects of the non-linear system are compensated by the DPD circuitry; and
DPD adaptation circuitry configured to adapt coefficients of the DPD circuitry based on feedback information derived from an output signal of the non-linear system, wherein the DPD adaptation circuitry is configured to adapt the plurality of non-linear terms of the pre-distortion function one non-linear term at a time.

2. The apparatus of claim 1, wherein the pre-distortion function is evaluated using a plurality of look-up tables (LUTs).

3. The apparatus of claim 2, wherein the LUTs are adapted one LUT at a time in a round robin fashion.

4. The apparatus of claim 2, wherein the DPD adaptation circuitry is configured to adapt coefficients of the LUTs by repeating multiple iterations with same samples of the output signal of the non-linear system.

5. The apparatus of claim 2, wherein the DPD adaptation circuitry is configured to adapt coefficients of the LUTs based on the pre-processed input data and the feedback information derived from the output signal of the non-linear system.

6. The apparatus of claim 2, wherein the DPD adaptation circuitry is configured to adapt coefficients of the LUTs based on the input data and the feedback information derived from the output signal of the non-linear system.

7. The apparatus of claim 2, wherein the DPD circuitry is configured to evaluate each LUT based on the input data and produce an LUT output value for each LUT and generate the pre-processed input data by applying the LUT output value as a gain to a corresponding function of the input data.

8. The apparatus of claim 1, wherein the DPD adaptation circuitry is configured to adapt the non-linear terms using least square algorithm.

9. The apparatus of claim 1, wherein the non-linear system is a power amplifier (PA).

10. A method for adapting digital pre-distortion (DPD), comprising:
processing, using DPD circuitry, input data using a pre-distortion function to generate pre-processed input data, wherein the pre-distortion function is represented as a sum of a plurality of non-linear terms;
sending the pre-processed input data to a non-linear system, wherein the pre-processed input data is processed by the non-linear system to generate an output signal, wherein non-linear effects of the non-linear system are compensated by the processing by the DPD circuitry;
receiving feedback information derived from the output signal of the non-linear system; and
adapting coefficients of the DPD circuitry based on the feedback information, wherein the plurality of non-linear terms of the pre-distortion function are adapted one non-linear term at a time.

11. The method of claim 10, wherein the pre-distortion function is evaluated using a plurality of look-up tables (LUTs).

12. The method of claim 11, wherein the LUTs are adapted one LUT at a time in a round robin fashion.

13. The method of claim 11, wherein coefficients of the LUTs are adapted by repeating multiple iterations with same samples of the output signal of the non-linear system.

14. The method of claim 11, wherein coefficients of the LUTs are adapted based on the pre-processed input data and the feedback information derived from the output signal of the non-linear system.

15. The method of claim 11, wherein coefficients of the LUTs are adapted based on the input data and the feedback information derived from the output signal of the non-linear system.

16. The method of claim 11, wherein each LUT is evaluated based on the input data to produce an LUT output value for each LUT and the pre-processed input data is generated by applying the LUT output value as a gain to a corresponding function of the input data.

17. The method of claim 10, wherein the non-linear terms are adapted using least square algorithm.

18. The method of claim 10, wherein the non-linear system is a power amplifier (PA).

19. A machine-readable medium including code, when executed, to cause a machine to perform a method of claim 10.
